(19) United States
(12) Patent Application Publication
(10) Pub. No.: US 2010/0046485 A1
(43) Pub. Date: Feb. 25, 2010

(54) METHOD AND APPARATUS FOR MULTIPLE CHANNEL ACCESS AND NAV RECOVERY

(75) Inventors: Simone Merlin, Solesino (IT); Santosh Abraham, San Diego, CA (US); Vinay Sridhara, Santa Clara, CA (US)

Correspondence Address: QUALCOMM INCORPORATED, 5775 MOREHOUSE DR., SAN DIEGO, CA, 92121, US

(73) Assignee: QUALCOMM Incorporated, San Diego, CA (US)

(21) Appl. No.: 12/349,726

(22) Filed: Jan. 7, 2009

Related U.S. Application Data
(60) Provisional application No. 61/090,531, filed on Aug. 20, 2008.

(51) Int. Cl. H04W 74/00

(52) U.S. Cl. 370/338

(57) ABSTRACT

An apparatus and method for communications are disclosed. The apparatus may include a processing system configured to send data to a node on a first channel and receive an acknowledgement to the data from the node, the processing system being further configured to determine whether a second channel is available from information contained in the acknowledgement.

### CROSS-REFERENCE TO RELATED APPLICATIONS

The present Application for Patent claims priority to Provisional Application No. 61/090,531 entitled “A METHOD FOR ACCESSING MULTIPLE CHANNELS AND RECOVERY LOST NAV INFORMATION IN HYBRID 802.11/VHT WIRELESS NETWORKS” filed Aug. 20, 2008, and assigned to the assignee hereof and hereby expressly incorporated by reference herein.

### BACKGROUND

I. Field

The following description relates generally to communication systems, and more particularly to multichannel communication systems.

II. Background

In order to address the issue of increasing bandwidth requirements that are demanded for wireless communications systems, different schemes are being developed to allow multiple user terminals to communicate with a single access point by sharing the channel resources while achieving high data throughputs. Multiple Input or Multiple Output (MIMO) technology represents one such approach that has recently emerged as a popular technique for the next generation communication systems. MIMO technology has been adopted in several emerging wireless communications standards such as the Institute of Electrical Engineers (IEEE) 802.11 standard. IEEE 802.11 denotes a set of Wireless Local Area Network (WLAN) air interface standards developed by the IEEE 802.11 committee for short-range communications (e.g., tens of meters to a few hundred meters).

Newly proposed VHT (Very High Throughput) networks are provided with the capability of using multiple channels for data transmission and reception. In order to enforce coexistence between VHT and 802.11 stations, whenever accessing any of the channels, VHT nodes are required to comply with the virtual carrier sensing mechanism specified by the 802.11 standard. Due to the limitations imposed by the physical layer design, VHT nodes might not be able to track a virtual carrier sensing status, as designated by a network allocation vector (NAV), on each channel. 802.11n defines a secondary channel access mechanism that only uses CCA (clear channel assessment) information before initiating a transmission on a secondary channel. This mechanism does not comply with the virtual carrier sensing specifications. Consequently, there is a need for a method and apparatus that allow for NAV detection in such circumstances.

### SUMMARY

According to an aspect of the disclosure, an apparatus for communications includes a processing system configured to send data to a node on a first channel and receive an acknowledgement to the data from the node, the processing system being further configured to determine whether a second channel is available from information contained in the acknowledgement.

According to another aspect of the disclosure, an apparatus for communications includes a processing system configured to receive data from a node on a first channel, the processing system being further configured to detect that a second channel is unavailable, and to provide information to the node indicating that the second channel is unavailable.

According to a further aspect of the disclosure, a method includes sending data to a node on a first channel, receiving an acknowledgement to the data from the node, and determining whether a second channel is available from information contained in the acknowledgement.

According to yet a further aspect of the disclosure, a method for communications includes receiving data from a node on a first channel, detecting that a second channel is unavailable, and providing information to the node indicating that the second channel is unavailable.

According to another aspect of the disclosure, an apparatus for communications includes means for sending data to a node on a first channel, means for receiving an acknowledgement to the data from the node, and means for determining whether a second channel is available from information contained in the acknowledgement.

According to yet another aspect of the disclosure, an apparatus for communications includes means for receiving data from a node on a first channel, means for detecting that a second channel is unavailable, and means for providing information to the node indicating that the second channel is unavailable.

According to yet a further aspect of the disclosure, a computer-program product for communications includes a machine-readable medium including instructions executable by a processing system to send data to a node on a first channel and receive an acknowledgement to the data from the node, and determine whether a second channel is available from information contained in the acknowledgement.

According to yet a further aspect of the disclosure, a computer-program product for communications, includes a machine-readable medium including instructions executable by a processing system to receive data from a node on a first channel, the processing system being further configured to detect that a second channel is unavailable, and provide information to the node indicating that the second channel is unavailable.

According to yet a further aspect of the disclosure, an access terminal, includes a processing system configured to send data to a node on a first channel and receive an acknowledgement to the data from the node, the processing system being further configured to determine whether a second channel is available from information contained in the acknowledgement, and a user interface supported by the processing system.

According to yet a further aspect of the disclosure, an access terminal, includes a processing system configured to receive data from a node on a first channel, the processing system being further configured to detect that a second channel is unavailable, and to provide information to the node indicating that the second channel is unavailable, and a user interface supported by the processing system.

According to yet a further aspect of the disclosure, an access point, includes a wireless network adapter configured to support a backhaul connection for a peer node to a network, and a processing system configured to send data to a node on a first channel and receive an acknowledgement to the data from the node, the processing system being further configured to determine whether a second channel is available from information contained in the acknowledgement.

According to yet a further aspect of the disclosure, an access point, includes a wireless network adapter configured to support a backhaul connection for a peer node to a network, and a processing system configured to receive data from a node on a first channel, the processing system being further configured to detect that a second channel is unavailable, and to provide information to the node indicating that the second channel is unavailable.

### BRIEF DESCRIPTION OF THE DRAWINGS

These and other sample aspects of the invention will be described in the detailed description that follow, and in the accompanying drawings, wherein

FIG. 1 is a diagram of a wireless communications network;

FIG. 2 illustrates a time line of message events in a NAV detection mechanism;

FIG. 3 illustrates a time line of message events in another NAV detection mechanism;

FIG. 4 illustrates a time line of message events in yet another NAV detection mechanism;

FIG. 5 is a block diagram of an example of signal processing functions of a PHY layer of a wireless node in the wireless communications network of FIG. 1;

FIG. 6 is a block diagram illustrating an exemplary hardware configuration for a processing system in a wireless node in the wireless communications network of FIG. 1;

FIG. 7 is a flow chart diagram illustrating a NAV detection and data transfer process;

FIG. 8 is a flow chart diagram illustrating another NAV detection and data transfer process.

FIG. 9A is a block diagram illustrating an operational stage of a NAV detection mechanism; and

FIG. 9B is a block diagram illustrating another operational stage of a NAV detection mechanism.

In accordance with common practice, some of the drawings may be simplified for clarity. Thus, the drawings may not depict all of the components of a given apparatus (e.g., device) or method. Finally, like reference numerals may be used to denote like features throughout the specification and figures.

### DETAILED DESCRIPTION

Various aspects of the invention are described more fully hereinafter with reference to the accompanying drawings. This invention may, however, be embodied in many different forms and should not be construed as limited to any specific structure or function presented throughout this disclosure. Rather, these aspects are provided so that this disclosure will be thorough and complete, and will fully convey the scope of the invention to those skilled in the art. Based on the teachings herein one skilled in the art should appreciate that the scope of the invention is intended to cover any aspect of the invention disclosed herein, whether implemented independently of or combined with any other aspect of the invention. For example, an apparatus may be implemented or a method may be practiced using any number of the aspects set forth herein. In addition, the scope of the invention is intended to cover such an apparatus or method which is practiced using other structure, functionality, or structure and functionality in addition to or other than the various aspects of the invention set forth herein. It should be understood that any aspect of the invention disclosed herein may be embodied by one or more elements of a claim.

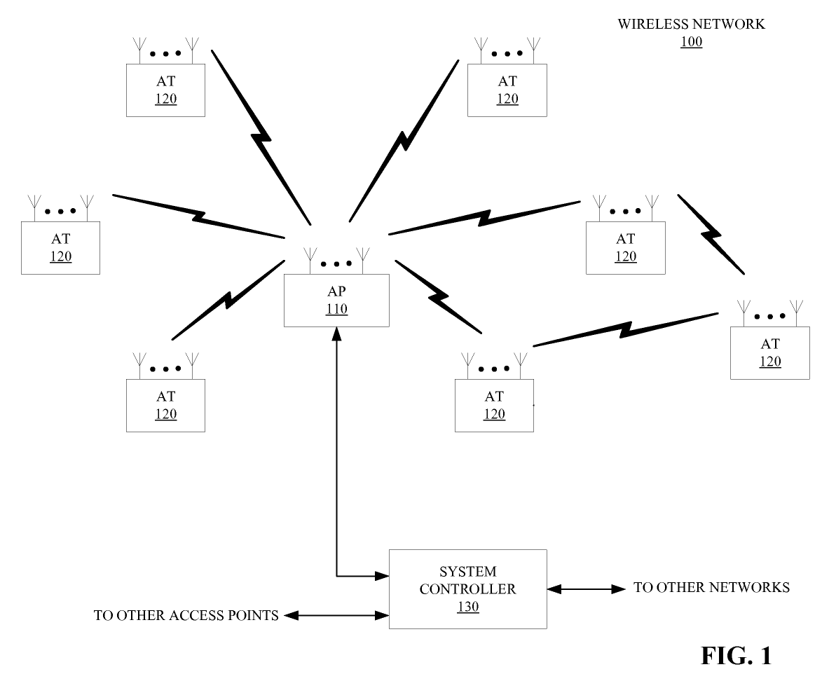

Several aspects of a wireless network will now be presented with reference to FIG. 1. The wireless network 100 is shown with several wireless nodes, generally designated as nodes 110 and 120. Each wireless node is capable of receiving and/or transmitting. In the detailed description that follows, the term “access point” is used to designate a transmitting node and the term “access terminal” is used to designate a receiving node for downlink communications, whereas the term “access point” is used to designate a receiving node and the term “access terminal” is used to designate a transmitting node for uplink communications. However, those skilled in the art will readily understand that other terminology or nomenclature may be used for an access point and/or access terminal. By way of example, an access point may be referred to as a base station, a base transceiver station, a station, a terminal, a node, an access terminal acting as an access point, or some other suitable terminology. An access terminal may be referred to as a user terminal, a mobile station, a subscriber station, a station, a wireless device, a terminal, a node, or some other suitable terminology. The various concepts described throughout this disclosure are intended to apply to all suitable wireless nodes regardless of their specific nomenclature.

The wireless network 100 may support any number of access points distributed throughout a geographic region to provide coverage for access terminals 120. A system controller 130 may be used to provide coordination and control of the access points, as well as access to other networks (e.g., Internet) for the access terminals 120. For simplicity, one access point 110 is shown. An access point is generally a fixed terminal that provides backhaul services to access terminals in the geographic region of coverage, however, the access point may be mobile in some applications. An access terminal, which may be fixed or mobile, utilizes the backhaul services of an access point or engages in peer-to-peer communications with other access terminals. Examples of access terminals include a telephone (e.g., cellular telephone), a laptop computer, a desktop computer, a Personal Digital Assistant (PDA), a digital audio player (e.g., MP3 player), a camera, a game console, or any other suitable wireless node.

The wireless network 100 may support MIMO technology. Using MIMO technology, an access point 110 may communicate with multiple access terminals 120 simultaneously using Spatial Division Multiple Access (SDMA). SDMA is a multiple access scheme which enables multiple streams transmitted to different receivers at the same time to share the same frequency channel and, as a result, provide higher user capacity. This is achieved by spatially precoding each data stream and then transmitting each spatially precoded stream through a different transmit antenna on the downlink. The spatially precoded data streams arrive at the access terminals with different spatial signatures, which enables each access terminal 120 to recover the data stream destined for that access terminal 120. On the uplink, each access terminal 120 transmits a spatially precoded data stream, which enables the access point 110 to identify the source of each spatially precoded data stream.

One or more access terminals 120 may be equipped with multiple antennas to enable certain functionality. With this configuration, multiple antennas at the access point 110 may be used to communicate with a multiple antenna access point to improve data throughput without additional bandwidth or transmit power. This may be achieved by splitting a high data rate signal at the transmitter into multiple lower rate data streams with different spatial signatures, thus enabling the receiver to separate these streams into multiple channels and properly combine the streams to recover the high rate data signal.

While portions of the following disclosure will describe access terminals that also support MIMO technology, the access point 110 may also be configured to support access terminals that do not support MIMO technology. This approach may allow older versions of access terminals (i.e., “legacy” terminals) to remain deployed in a wireless network, extending their useful lifetime, while allowing newer MIMO access terminals to be introduced as appropriate.

In the detailed description that follows, various aspects of the invention will be described with reference to a MIMO system supporting any suitable wireless technology, such as Orthogonal Frequency Division Multiplexing (OFDM). OFDM is a spread-spectrum technique that distributes data over a number of subcarriers spaced apart at precise frequencies. The spacing provides “orthogonality” that enables a receiver to recover the data from the subcarriers. An OFDM system may implement IEEE 802.11, or some other air interface standard. Other suitable wireless technologies include, by way of example, Code Division Multiple Access (CDMA), Time Division Multiple Access (TDMA), or any other suitable wireless technology, or any combination of suitable wireless technologies. A CDMA system may implement with IS-2000, IS-95, IS-856, Wideband-CDMA (WCDMA), or some other suitable air interface standard. A TDMA system may implement Global System for Mobile Communications (GSM) or some other suitable air interface standard. As those skilled in the art will readily appreciate, the various aspects of this invention are not limited to any particular wireless technology and/or air interface standard.

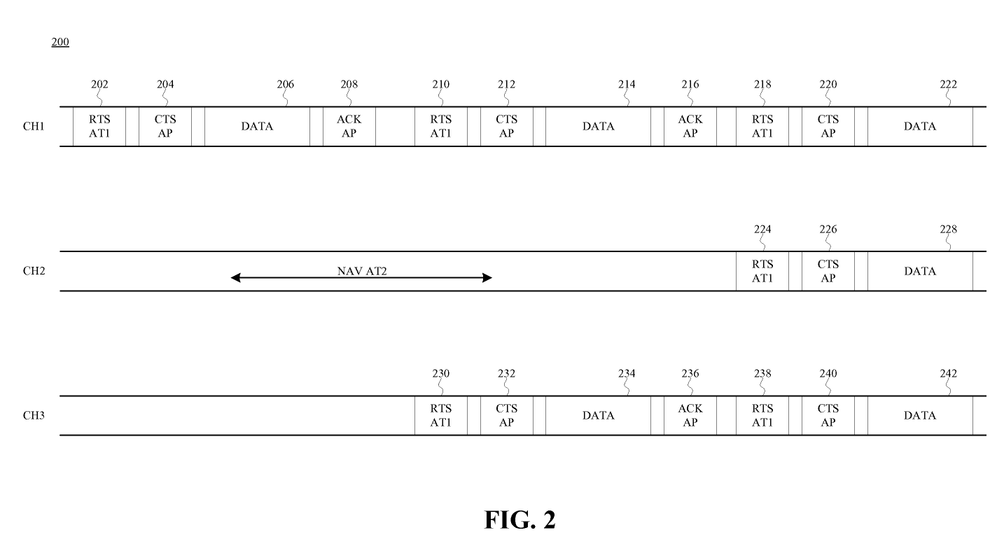

FIG. 2 illustrates a time line of message events in a NAV detection mechanism 200. In FIG. 2, an access point (AP) exchanges messages with an access terminal AT1 over three channels CH1, CH2, CH3. Specifically, the AP is configured to perform NAV detection on the channels as a proxy for the access terminal AT1. It should be noted that the number of access terminals and channels is not limited, and the AP may perform NAV detection on any number of channels for any number of access terminals, as required by circumstances.

The AP may correspond to the AP 110 in FIG. 1, and the access terminal AT1 may correspond to one of the various access terminals AT 120 within the wireless network 100.

The access terminal AT1 may initiate communication by transmitting a message indicating to the AP that it is preparing to transmit data to the AP across channel CH1. This message may be referred to as a ready-to-send (RTS) message or some other nomenclature. For example, as shown in FIG. 2, the AT1 transmits RTS AT1 202 across channel CH1.

Upon receipt of the RTS AT1 202 message, the AP is triggered to determine whether channel CH1 is available for communication. Once the AP determines that the channel CH1 is available, it transmits a message indicating to the access terminal AT1 that it is free to transmit a response across the channel CH1. This message may be referred to as a clear-to-send (CTS) message or some other nomenclature. For example, as shown in FIG. 2, the AP transmits message CTS AP 204 to the access terminal AT1 across channel CH1.

Once the access terminal AT1 receives the CTS AP 204 message, it begins the transmission of a data block DATA 206 to the AP across channel CH1. During this transmission, however, another access terminal AT2 may perform some communication on channel CH2 and set a NAV duration on channel CH2.

It should be noted that the transmission of various messages, such as RTS and CTS messages, from either the AP or any access terminal may trigger a response in access terminals or devices that are within range of the transmission, but for which the specific message was not intended. This response protects the transmitting device on the respective channel for a predetermined duration and may be referred to as a NAV response or some other nomenclature. The predetermined duration of the NAV response may likewise be referred to as a NAV duration. NAV is the mechanism provided for virtual carrier sensing in 802.11. As shown in FIG. 2, the access terminal AT2 sets the NAV duration on channel CH2 in order to protect the channel from outside interference by other access terminals. The NAV durations set by the access terminal AT1 and the AP during their respective transmissions on channels CH1, CH2, and CH3 are not shown in FIG. 2 so as not to obscure the NAV detection mechanism 200.

Because access terminal AT1 is transmitting data block DATA 206 across channel CH1 at the time the NAV duration is set on channel CH2, the access terminal AT1 may not be able to detect the initiation of the NAV duration. The AP, however, may be set to detect the initiation of any NAV durations on channels CH2 and CH3 whenever it itself is not transmitting any data. Accordingly, during the data block DATA 206 transmission by access terminal AT1, the AP may detect the initiation of the NAV duration on CH2. The AP may then determine which of the channels is available for transmission of data. For example, the AP may determine that channel CH2 is not available because of the set NAV duration by access terminal AT2, but that channel CH3 is available as it is free of any communication activity.

After the access terminal AT1 completes the transmission of data block DATA, and the AP receives the data block DATA 206, the AP transmits an acknowledgement message ACK AP 208 indicating to the access terminal AT1 the successful receipt of the data block DATA 206. The ACK AP 208 message may also include information indicating channel availability. For example, in the NAV detection mechanism 200, the ACK AP 208 may include information indicating to the access terminal AT1 that channel CH2 is unavailable and channel CH3 is available.

After receipt of the ACK AP 208 message, the access terminal AT1 may determine whether channel CH1 is still available for transmission so as to avoid contention with nay other access terminals. If the access terminal AT1 determines that channel CH1 is available, it may initiate a random “backoff” time period to minimize the probability of a potential collision on channel CH1. This time period may be implemented by a distributed coordination function (DCF), which is a fundamental MAC technique of the 802.11 standard. Based on the information provided in the ACK AP 208, access terminal AT1 proceeds to transmit a RTS AT1 230 message across channel CH3 to the AP. The access terminal AT1 may also proceed to transmit a RTS AT1 210 message across channel CH1 to the AP for preparation of additional data transmission. Again, in response to the RTS AT1 210 and 230 messages, the AP transmits CTS AP 212 and 232 messages to access terminal AT1 across channels CH1 and CH3, respectively. Upon receipt of the CTS AP 212 and 232 messages, the access terminal AT1 transmits data blocks DATA 214 and 234 to the AP across channels CH1 and CH3, respectively. As before, during the transmission of the data blocks DATA 214 and 234, the AP listens for any NAV initiations on the other channels not in use by the AP and AT1. In the example of FIG. 2, the AP may listen to channel CH2 and determine that channel CH2 is available for communication due to the absence of any NAV durations initiated by other access terminals.

Once the AP receives the data blocks DATA 214 and 234, it transmits acknowledgement messages ACK 216 and 236 to the access terminal AT1 across channels CH1 and CH3, respectively. Only one of the messages ACK AP 216 and 236 needs to include the information required to inform access terminal AT1 of the channel availability status. The ACK message used to bear the channel availability information may depend on the status of the channel over which it is being transmitted, such as channel condition, bandwidth, or whether the channel is a primary channel. In the example of FIG. 2, the message ACK AP 216 transmitted across channel CH1 may carry such information to the access terminal AT1. The access terminal AT1 receives the message ACK AP 216 and from the channel availability information within the message ACK AP 216 may determine that channel CH2 is now available.

After the access terminal AT1 determines the availability of channel CH2, it may also independently confirm that channels CH1 and CH3 are still available. Again, in order to minimize any potential collisions, the access terminal AT1 may initiate a random “backoff” time period on channels CH1, CH2, and CH3. The access terminal AT1 may then proceed to transmit messages RTS 218, 224, and 238 to the AP across all three channels CH1, CH2, and CH3, respectively, indicating that it is ready to transmit. The AP responds to the access terminal AT1 with messages CTS 220, 226, and 240 across channels CH1, CH2, and CH3, respectively, authorizing the access terminal AT1 to transmit its data. The access terminal receives the authorization messages and transmits the data blocks 222, 228, and 242 to the AP across channels CH1, CH2, and CH3, respectively.

Although in the example of FIG. 2 it is the AP that detects and provides channel availability information to the access terminal AT1, the access terminal AT1 is likewise capable of performing the same channel availability detection and is capable of informing the AP as well as other access terminals, such as AT2, of available and unavailable channels.

It should be noted that between each message exchanged between the AP and the access terminal AT1, there exists a period of time during which no information is transmitted. This period of time may be referred to as a short interframe space (SIFS) or some other nomenclature. The purpose of the SIFS is to increase the speed of data exchange between the AP and the access terminal AT1 by limiting the amount of time the AP or the access terminal can take to respond, and by limiting the amount of time the AP and the access terminal must remain in the receiving mode when awaiting receipt of the response.

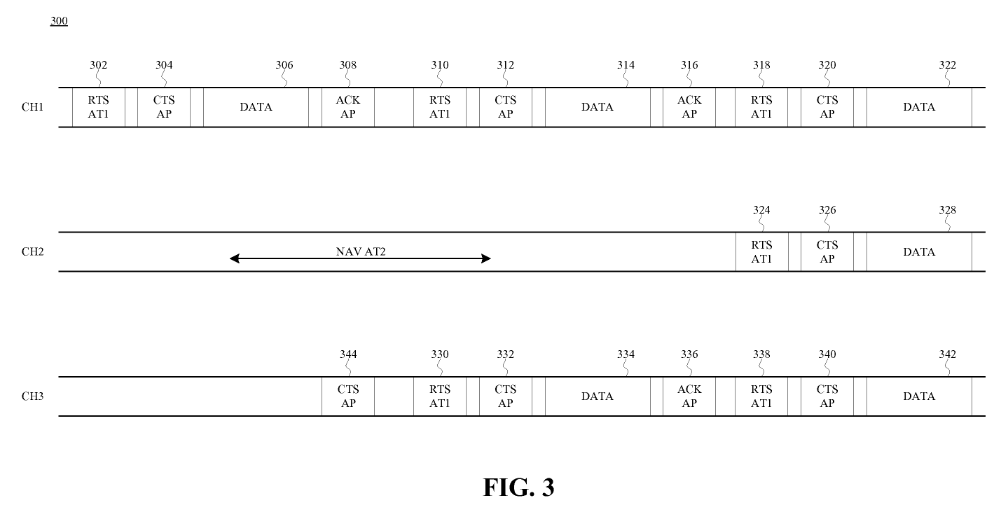

FIG. 3 illustrates a time line of message events in a NAV detection mechanism 300. The mechanism 300 is similar to the mechanism 200 of FIG. 2, but includes an additional transmission of a CTS AP 344 message from the AP to the access terminal AT1 across channel CH3. The AP may transmit the CTS AP 344 message across channel CH3 at the same time it transmits message ACK AP 308 across channel CH1. By transmitting the CTS AP 344 message across channel CH3 reserves the channel CH3 for communication with the access terminal AT1, and protects the channel CH3 from outside interference by other access terminals by setting a NAV duration (not shown) on channel CH3.

The mechanism of transmitting RTS, CTS DATA, and ACK messages 302-342 of FIG. 3 corresponds to that of messages 202-242 of FIG. 2, respectively, and as such, their respective descriptions are omitted.

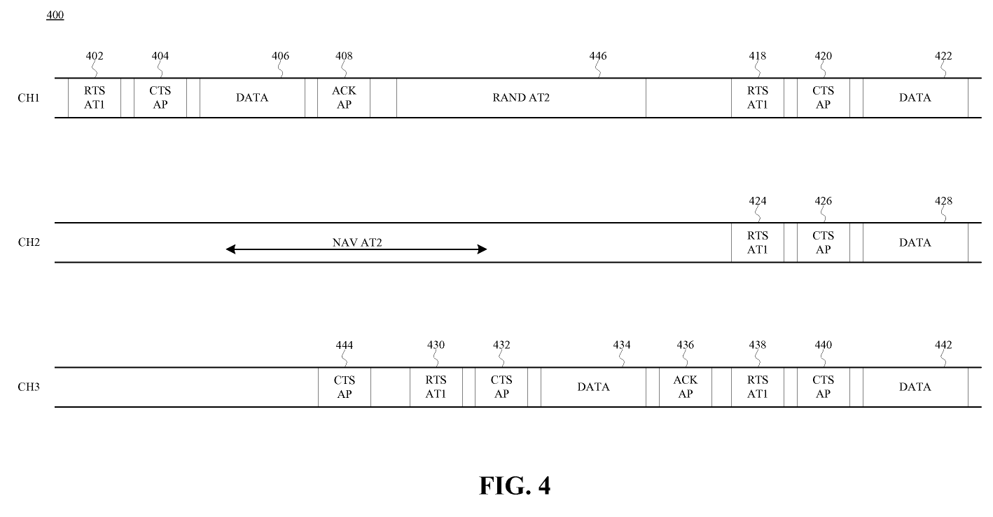

FIG. 4 illustrates a time line of message events in a NAV detection mechanism 400. The mechanism 400 is similar to the mechanism 300 of FIG. 3, but includes a random transmission RAND AT2 446 across channel CH1 from some other access terminal, such as access terminal AT2. The transmission RAND AT2 446 may not be designated to either the access terminal AT1 or the AP, and may be, for example, a communication across channel CH1 between some other access terminals.

In this case, the access terminal AT1 does not have access to channel CH1 after it receives message ACK AP 408 from the AP. As the channel CH2 is also unavailable, the access terminal AT1 may initiate a “backoff” via the DCF technique on channel CH3 in order to minimize any potential collisions on the channel.

The mechanism of transmitting RTS, CTS DATA, and ACK messages 402-408 and 418-344 of FIG. 4 corresponds to that of messages 302-308 and 318-344 of FIG. 3, respectively, and as such, their respective descriptions are omitted.

It should be noted that the AP may transmit a monitoring request (not shown) to all access terminals prior to a transmission to receive a NAV status response from the access terminals so as to determine which channels are available.

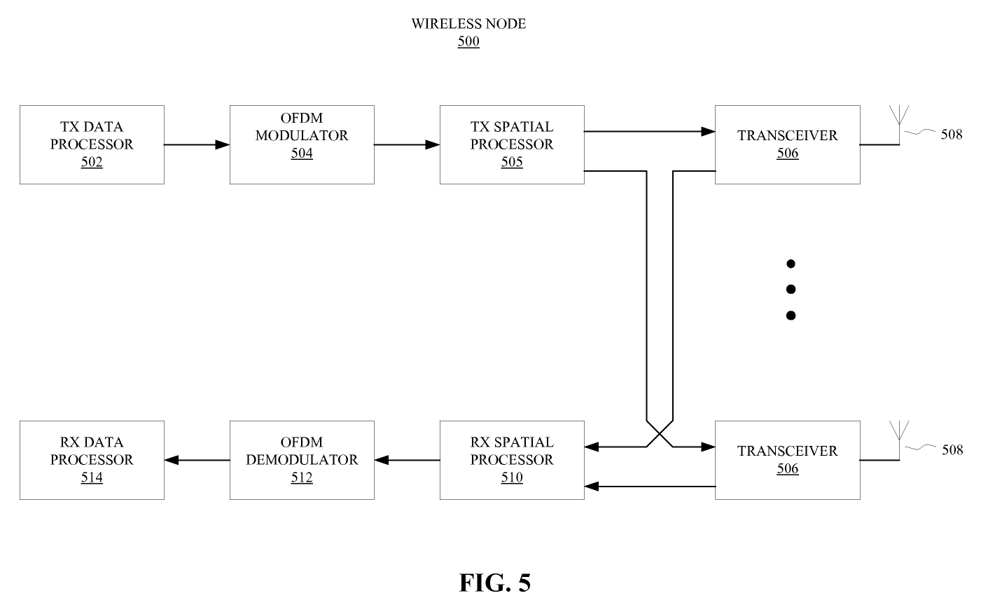

The wireless node, whether an access point or access terminal, may be implemented with a protocol that utilizes a layered structure that includes a physical (PHY) layer that implements all the physical and electrical specifications to interface the wireless node to the shared wireless channel. FIG. 5 is a conceptual block diagram illustrating an example of the PHY layer. In a transmit mode, a TX data processor 502 may be used to receive data from the MAC layer and encode (e.g., Turbo code) the data to facilitate forward error correction (FEC) at the receiving node. The encoding process results in a sequence of code symbols that may be blocked together and mapped to a signal constellation by the TX data processor 502 to produce a sequence of modulation symbols.

In wireless nodes implementing OFDM, the modulation symbols from the TX data processor 502 may be provided to an OFDM modulator 504. The OFDM modulator splits the modulation symbols into parallel streams. Each stream is then mapped to an OFDM subcarrrier and then combined together using an Inverse Fast Fourier Transform (IFFT) to produce a time domain OFDM stream.

A TX spatial processor 506 performs spatial processing on the OFDM stream. This may be accomplished by spatially preceding each OFDM and then providing each spatially precoded stream to a different antenna 508 via a transceiver 506. Each transmitter 506 modulates an RF carrier with a respective precoded stream for transmission over the wireless channel.

In a receive mode, each transceiver 506 receives a signal through its respective antenna 508. Each transceiver 506 may be used to recover the information modulated onto an RF carrier and provide the information to a RX spatial processor 510.

The RX spatial processor 510 performs spatial processing on the information to recover any spatial streams destined for the wireless node 500. The spatial processing may be performed in accordance with Channel Correlation Matrix Inversion (CCMI), Minimum Mean Square Error (MMSE), Soft Interference Cancellation (SIC), or some other suitable technique. If multiple spatial streams are destined for the wireless node 500, they may be combined by the RX spatial processor 510.

In wireless nodes implementing OFDM, the stream (or combined stream) from the RX spatial processor 510 is provided to an OFDM demodulator 512. The OFDM demodulator 512 converts the stream (or combined stream) from time-domain to the frequency domain using a Fast Fourier Transfer (FFT). The frequency domain signal comprises a separate stream for each subcarrrier of the OFDM signal. The OFDM demodulator 512 recovers the data (i.e., modulation symbols) carried on each subcarrier and multiplexes the data into a stream of modulation symbols.

A RX data processor 514 may be used to translate the modulation symbols back to the correct point in the signal constellation. Because of noise and other disturbances in the wireless channel, the modulation symbols may not correspond to an exact location of a point in the original signal constellation. The RX data processor 514 detects which modulation symbol was most likely transmitted by finding the smallest distance between the received point and the location of a valid symbol in the signal constellation. These soft decisions may be used, in the case of Turbo codes, for example, to compute a Log-Likelihood Ratio (LLR) of the code symbols associated with the given modulation symbols. The RX data processor 514 then uses the sequence of code symbol LLRs in order to decode the data that was originally transmitted before providing the data to the MAC layer.

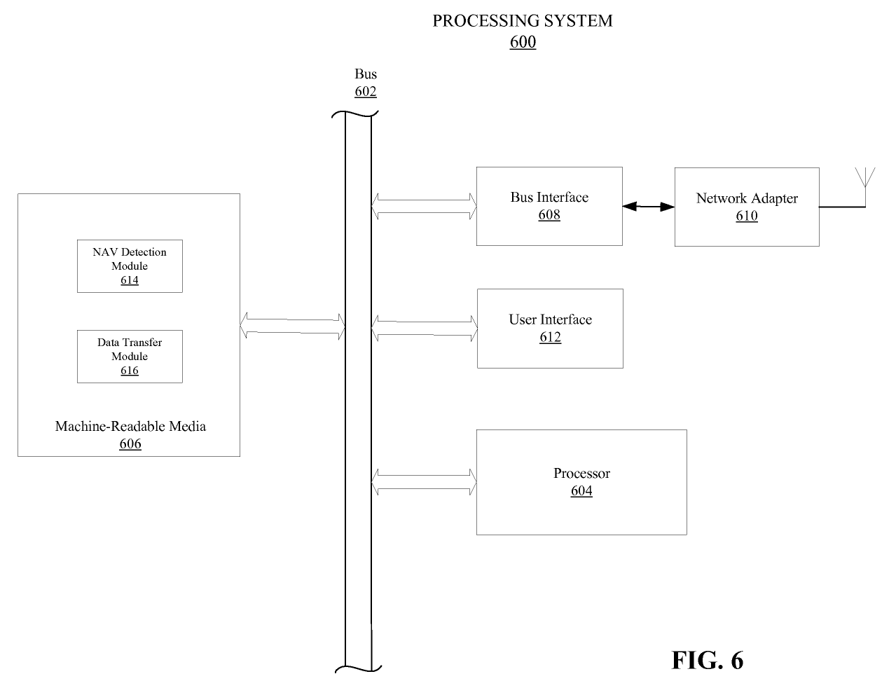

FIG. 6 is a conceptual diagram illustrating an example of a hardware configuration for a processing system in a wireless node. In this example, the processing system 600 may be implemented with a bus architecture represented generally by bus 602. The bus 602 may include any number of interconnecting buses and bridges depending on the specific application of the processing system 600 and the overall design constraints. The bus links together various circuits including a processor 604, machine-readable media 606, and a bus interface 608. The bus interface 608 may be used to connect a network adapter 610, among other things, to the processing system 600 via the bus 602. The network adapter 610 may be used to implement the signal processing functions of the PHY layer. In the case of an access terminal 110 (see FIG. 1), a user interface 612 (e.g., keypad, display, mouse, joystick, etc.) may also be connected to the bus. The bus 602 may also link various other circuits such as timing sources, peripherals, voltage regulators, power management circuits, and the like, which are well known in the art, and therefore, will not be described any further.

The processor 604 is responsible for managing the bus and general processing, including the execution of software stored on the machine-readable media 606. The processor 604 may be implemented with one or more general-purpose and/or special-purpose processors. Examples include microprocessors, microcontrollers, DSP processors, and other circuitry that can execute software. Software shall be construed broadly to mean instructions, data, or any combination thereof, whether referred to as software, firmware, middleware, microcode, hardware description language, or otherwise. Machine-readable media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable may be embodied in a computer-program product. The computer-program product may comprise packaging materials.

In the hardware implementation illustrated in FIG. 6, the machine-readable media 606 is shown as part of the processing system 600 separate from the processor 604. However, as those skilled in the art will readily appreciate, the machine-readable media 606, or any portion thereof, may be external to the processing system 600. By way of example, the machine-readable media 606 may include a transmission line, a carrier wave modulated by data, and/or a computer product separate from the wireless node, all which may be accessed by the processor 604 through the bus interface 608. Alternatively, or in addition to, the machine readable media 604, or any portion thereof, may be integrated into the processor 604, such as the case may be with cache and/or general register files.

The processing system 600 may be configured as a general-purpose processing system with one or more microprocessors providing the processor functionality and external memory providing at least a portion of the machine-readable media 606, all linked together with other supporting circuitry through an external bus architecture. Alternatively, the processing system 600 may be implemented with an ASIC (Application Specific Integrated Circuit) with the processor 604, the bus interface 608, the user interface 612 in the case of an access terminal), supporting circuitry (not shown), and at least a portion of the machine-readable media 606 integrated into a single chip, or with one or more FPGAs (Field Programmable Gate Array), PLDs (Programmable Logic Device), controllers, state machines, gated logic, discrete hardware components, or any other suitable circuitry, or any combination of circuits that can perform the various functionality described throughout this disclosure. Those skilled in the art will recognize how best to implement the described functionality for the processing system 600 depending on the particular application and the overall design constraints imposed on the overall system.

The machine-readable media 606 is shown with a number of software modules. The software modules include instructions that when executed by the processor 604 cause the processing system 600 to perform various functions. Each software module may reside in a single storage device or distributed across multiple storage devices. By way of example, a software module may be loaded into RAM from a hard drive when a triggering event occurs. During execution of the software module, the processor 604 may load some of the instructions into cache to increase access speed. One or more cache lines may then be loaded into a general register file for execution by the processor 604. When referring to the functionality of a software module below, it will be understood that such functionality is implemented by the processor 604 when executing instructions from that software module.

In this implementation, the machine-readable media 606 may include modules for performing the functions of all layers above the physical layer; however, in order to avoid obscuring the implementation, only a NAV detection module 614 and a data transfer module 616 are shown. The NAV detection module 614 may be used to implement all or part of a NAV detection process at the wireless nodes, such as the AP 110 and the various access terminals AT 120 and AT1, for example. The data transfer module 616 may be used to control the transfer of data blocks (e.g., DATA) and acknowledgement messages (e.g., ACK AP) between the wireless nodes.

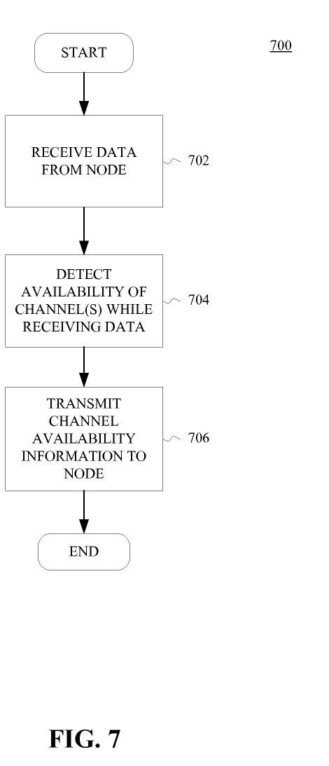

An example of the NAV detection and data transfer process 700, such as that which may be implemented via the combination of the channel allocation module 614 and the data transfer module 616, will now be described with respect to the flow chart illustrated in FIG. 7. The NAV detection and data transfer process 700 may be implemented specifically at a wireless node (e.g., AP) responsible for detecting NAV presence on various channels as a proxy for various other wireless nodes (e.g., AT). More specifically, the process of block 704 may be performed by the NAV detection module 614 of the AP, whereas the process of blocks 702 and 706 may be performed by the data transfer module 616 of the AP, for example.

As shown in FIG. 7, in block 702, data is received from a node across a first channel. For example, an AP may receive a data block from an access terminal AT across channel CH1.

In block 704, the availability of other channels is detected during the receipt of the data. For example, while the AP is receiving the data block from the access terminal AT, it may detect whether there was a NAV initiation on a second channel.

In block 706, channel availability information is transmitted to the node. For example, the AP may transmit the channel availability information as part of an acknowledgement message ACK to the access terminal AT across the first channel.

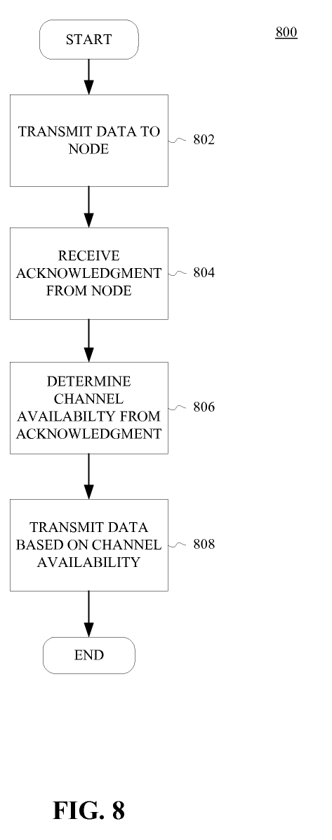

Another example of a channel allocation process 800, such as that which may also be implemented via the combination of the NAV detection module 614 and the data transfer module 616, will now be described with respect to the flow chart illustrated in FIG. 8. The NAV detection process 800 may be implemented specifically at a wireless node (e.g., AT). More specifically, the process of block 806 may be performed by the NAV detection module 614 of the AT, whereas the process of blocks 802-804 and 808 may be performed by the data transfer module 616 of the AT, for example.

As shown in FIG. 8, in block 802, data is transmitted to a node. For example, an access terminal AT may transmit a data block to an AP across a first channel.

In block 804, an acknowledgement is received from the node. For example, the AT may receive from the AP an acknowledgment message ACK including channel availability information.

In block 806, channel availability is determined from the information in the acknowledgement. For example, the access terminal may extract the embedded channel availability from the acknowledgement message ACK and determine which channels are available for communication.

In block 808, data is transmitted based on the channel availability information. For example, the AT may transmit data to the AP only across those channels that were designated as available for communication in the channel availability information.

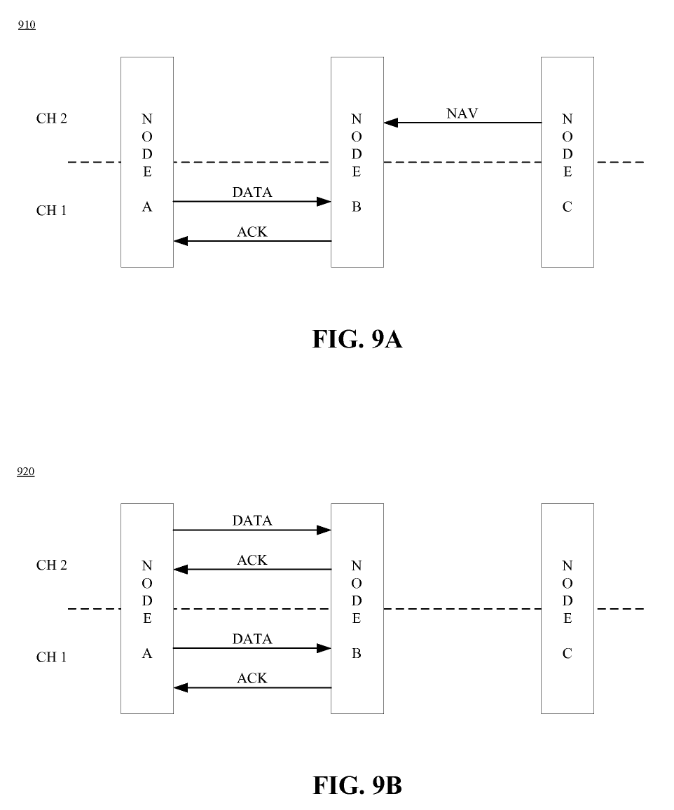

FIGS. 9A-9B illustrate through block diagrams two operational stages of a NAV detection mechanism. Specifically, FIG. 9A illustrates a first stage 910 where DATA and ACK transmissions are exchanged between nodes A and B on channel CH1, and node C initiates a NAV duration on channel CH2. Nodes A, B, and C, may correspond, for example, to terminals AT1, AP, and AT2, respectively, of FIGS. 2-4. As previously discussed with reference to FIG. 2, while node A is transmitting DATA to node B across channel CH1, node B may be set to detect the NAV initiation by node C on channel CH2. Node B may then transmit the ACK message to node A indicating that channel CH2 is unavailable, preventing any potential communication interference on CH2.

FIG. 9B illustrates a second stage 920 where DATA and ACK transmissions are exchanged between nodes A and B on both channels CH1 and CH2. As previously discussed with reference to FIG. 2, when node B detects that there is no activity on channel CH2, it transmits to node A an ACK message on CH1 indicating the availability of CH2. Consequently, node A, after having determined channel availability, proceeds to transmit DATA to node B across both channels CH1 and CH2.

It is understood that any specific order or hierarchy of steps described in the context of a software module is being presented to provide an examples of a wireless node. Based upon design preferences, it is understood that the specific order or hierarchy of steps may be rearranged while remaining within the scope of the invention.

Although various aspects of the present invention have been described as software implementations, those skilled in the art will readily appreciate that the various software modules presented throughout this disclosure may be implemented in hardware, or any combination of software and hardware. Whether these aspects are implemented in hardware or software depends upon the particular application and design constraints imposed on the overall system. Skilled artisans may implement the described functionality in varying ways for each particular application, but such implementation decisions should not be interpreted as causing a departure from the scope of the invention.

The previous description is provided to enable any person skilled in the art to fully understand the full scope of the invention. Modifications to the various configurations disclosed herein will be readily apparent to those skilled in the art. Thus, the claims are not intended to be limited to the various aspects of the invention described herein, but is to be accorded the full scope consistent with the language of claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.”

What is claimed is:

1. An apparatus for communications, comprising:
a processing system configured to send data to a node on a first channel and receive an acknowledgement to the data from the node, the processing system being further configured to determine whether a second channel is available from information contained in the acknowledgement.

2. The apparatus of claim 1 wherein the processing system is further configured to receive the acknowledgement on the first channel.

3. The apparatus of claim 1 wherein the processing system is further configured to send a request to transmit to the node before sending the data.

4. The apparatus of claim 1 wherein the processing system is further configured to send additional data to the node on the first and second channels if the processing system determines from the information contained in the acknowledgement that the second channel is available.

5. The apparatus of claim 1 wherein the processing system is further configured to not use the second channel to send additional data to the node if the processing system determines from the information contained in the acknowledgement that the second channel is unavailable.

6. The apparatus of claim 1 wherein the processing system is further configured to determine a time period that the second channel is unavailable from the information contained in the acknowledgement if the processing system determines that the second channel is unavailable.

7. An apparatus for communications, comprising:
a processing system configured to receive data from a first node on a first channel, the processing system being further configured to detect that a second channel is unavailable, and to provide information to the first node indicating that the second channel is unavailable.

8. The apparatus of claim 7 wherein the processing system is further configured to detect that the second channel is unavailable from a message received from a second node prior to the second node receiving a transmission on the second channel.

9. The apparatus of claim 7 wherein the processing system is further configured to detect that the second channel is unavailable while receiving the data from the first node.

10. The apparatus of claim 7 wherein the processing system is further configured to send an acknowledgement of the data to the first node, the processing being further configured to embed the information in the acknowledgement.

11. The apparatus of claim 7 wherein the processing system is further configured to send the information to the first node on the first channel.

12. The apparatus of claim 7 wherein the processing system is further configured to receive a request to transmit from the first node before receiving the data.

13. The apparatus of claim 12 wherein the processing system is further configured to generate a message for transmission in response to the request, the message indicating that the processing system will receive the data on the first channel.

14. The apparatus of claim 7 wherein the processing system is further configured to provide information to the first node indicating a time period that the second channel is unavailable.

15. The apparatus of claim 14 wherein the processing system is further configured to determine the time period that the second channel is unavailable from a message received from a second node prior to the second node receiving a transmission on the second channel.

16. The apparatus of claim 14 wherein the processing system is further configured to generate a message for transmission after the time period, the message indicating that the processing system will receive additional data on the second channel.

17. A method for communications, comprising:
sending data to a node on a first channel;
receiving an acknowledgement to the data from the node; and
determining whether a second channel is available from information contained in the acknowledgement.

18. The method of claim 17 wherein the acknowledgment is received on the first channel.

19. The method of claim 17 further comprising sending a request to transmit to the node before sending the data.

20. The method of claim 17 further comprising sending additional data to the node on the first and second channels if from the information contained in the acknowledgement it is determined that the second channel is available.

21. The method of claim 17 further comprising not using the second channel to send additional data to the node if from the information contained in the acknowledgement it is determined that the second channel is unavailable.

22. The method of claim 17 further comprising determining a time period that the second channel is unavailable from the information contained in the acknowledgement if it is determined that the second channel is unavailable.

23. A method for communications, comprising:
receiving data from a first node on a first channel;
detecting that a second channel is unavailable; and
providing information to the first node indicating that the second channel is unavailable.

24. The method of claim 23 wherein the second channel is detected as unavailable from a message received from a second node prior to the second node receiving a transmission on the second channel.

25. The method of claim 23 wherein the second channel is detected as unavailable while receiving the data from the first node.

26. The method of claim 23 further comprising sending an acknowledgement of the data to the first node, and embedding the information in the acknowledgement.

27. The method of claim 23 wherein further comprising sending the information to the first node on the first channel.

28. The method of claim 23 further comprising receiving a request to transmit from the first node before receiving the data.

29. The method of claim 28 further comprising generating a message for transmission in response to the request, the message indicating that the data will be received on the first channel.

30. The method of claim 23 further comprising providing information to the first node indicating a time period that the second channel is unavailable.

31. The method of claim 30 further comprising determining the time period that the second channel is unavailable from a message received from a second node prior to the second node receiving a transmission on the second channel.

32. The method of claim 30 further comprising generating a message for transmission after the time period, the message indicating additional data will be received on the second channel.

33. An apparatus for communications, comprising:
means for sending data to a node on a first channel;
means for receiving an acknowledgement to the data from the node; and
means for determining whether a second channel is available from information contained in the acknowledgement.

34. The apparatus of claim 33 wherein the means for receiving is configured to receive the acknowledgement on the first channel.

35. The apparatus of claim 33 further comprising means for sending a request to transmit to the node before sending the data.

36. The apparatus of claim 33 further comprising means for sending additional data to the node on the first and second channels if from the information contained in the acknowledgement it is determined that the second channel is available.

37. The apparatus of claim 33 further comprising means for not using the second channel to send additional data to the node if from the information contained in the acknowledgement it is determined that the second channel is unavailable.

38. The apparatus of claim 33 further comprising means for determining a time period that the second channel is unavailable from the information contained in the acknowledgement if it is determined that the second channel is unavailable.

39. An apparatus for communications, comprising:
means for receiving data from a first node on a first channel;
means for detecting that a second channel is unavailable; and
means for providing information to the first node indicating that the second channel is unavailable.

40. The apparatus of claim 39 wherein the means for detecting is configured to detect that the second channel is unavailable from a message received from a second node prior to the second node receiving a transmission on the second channel.

41. The apparatus of claim 39 wherein the means for detecting that the second channel is unavailable is configured to detect while receiving the data from the first node.

42. The apparatus of claim 39 further comprising means for sending an acknowledgement of the data to the first node, and embedding the information in the acknowledgement.

43. The apparatus of claim 39 further comprising means for sending the information to the first node on the first channel.

44. The apparatus of claim 39 further comprising means for receiving a request to transmit from the first node before receiving the data.

45. The apparatus of claim 44 further comprising means for generating a message for transmission in response to the request, the message indicating that the data will be received on the first channel.

46. The apparatus of claim 39 further comprising means for providing information to the first node indicating a time period that the second channel is unavailable.

47. The apparatus of claim 46 further comprising means for determining the time period that the second channel is unavailable from a message received from a second node prior to the second node receiving a transmission on the second channel.

48. The apparatus of claim 46 further comprising means for generating a message for transmission after the time period, the message indicating additional data will be received on the second channel.

49. An apparatus for communications, comprising:
a processing system configured to send data to a node on a first channel and receive an acknowledgement to the data from the node, the processing system being further configured to determine whether at least one of a plurality of channels is available from information contained in the acknowledgement.

50. The apparatus of claim 49 wherein the processing system is further configured to receive the acknowledgement on the first channel.

51. The apparatus of claim 49 wherein the processing system is further configured to send a request to transmit to the node before sending the data.

52. The apparatus of claim 49 wherein the processing system is further configured to send additional data to the node on the first channel and the at least one of the plurality of channels if the processing system determines from the information contained in the acknowledgement that the at least one of the plurality of channels is available.

53. The apparatus of claim 49 wherein the processing system is further configured to not use the at least one of the plurality of channels to send additional data to the node if the processing system determines from the information contained in the acknowledgement that the at least one of the plurality of channels is unavailable.

54. The apparatus of claim 49 wherein the processing system is further configured to determine a time period that the at least one of the plurality of channels is unavailable from the information contained in the acknowledgement if the processing system determines that the at least one of the plurality of channels is unavailable.

55. A computer-program product for communication, comprising:
a machine-readable medium comprising instructions executable by a processing system to:
send data to a node on a first channel and receive an acknowledgement to the data from the node; and
determine whether a second channel is available from information contained in the acknowledgement.

56. A computer-program product for communication, comprising:
a machine-readable medium comprising instructions executable by a processing system to:
receive data from a node on a first channel, the processing system being further configured to detect that a second channel is unavailable; and
provide information to the node indicating that the second channel is unavailable.

57. An access terminal, comprising:
a processing system configured to send data to a node on a first channel and receive an acknowledgement to the data from the node, the processing system being further configured to determine whether a second channel is available from information contained in the acknowledgement; and
a user interface supported by the processing system.

58. An access terminal, comprising:
a processing system configured to receive data from a node on a first channel, the processing system being further configured to detect that a second channel is unavailable, and to provide information to the node indicating that the second channel is unavailable; and
a user interface supported by the processing system.

59. An access point, comprising:
a wireless network adapter configured to support a backhaul connection for a peer node to a network; and
a processing system configured to send data to a node on a first channel and receive an acknowledgement to the data from the node, the processing system being further configured to determine whether a second channel is available from information contained in the acknowledgement.

60. An access point, comprising:
a wireless network adapter configured to support a backhaul connection for a peer node to a network; and
a processing system configured to receive data from a node on a first channel, the processing system being further configured to detect that a second channel is unavailable, and to provide information to the node indicating that the second channel is unavailable.
